(19) United States
(12) Patent Application Publication
(10) Pub. No.: US 2019/0032641 A1
(43) Pub. Date: Jan. 31, 2019

(54) METHOD FOR MONITORING A WIND TURBINE

(71) Applicant: Wobben Properties GmbH, Aurich (DE)

(72) Inventor: Jürgen STOLTENJOHANNES, Aurich (DE)

(21) Appl. No.: 15/765,677

(22) PCT Filed: Oct. 7, 2016
(86) PCT No.: PCT/EP2016/074004

§ 371 Date: Apr. 3, 2018

(30) Foreign Application Priority Data
Oct. 7, 2015 (DE) 10 2015 117 032.9

(51) Int. Cl. F03D 17/00; F03D 7/02; F03D 80/40

(52) U.S. Cl. CPC F03D 17/00; F03D 7/0204; F03D 7/0224; F03D 7/0276; F05B 2270/81; F03D 80/40; F05B 2260/80; F05B 2260/96; F05B 2270/333; F03D 7/028

(57) ABSTRACT

A method for monitoring a wind power installation having a nacelle is provided. The method includes recording a sound using at least one acoustic sensor arranged outside and on the nacelle and evaluating the recorded sound to detect an operating state of the wind power installation.

### BACKGROUND

### Technical Field

The present invention relates to a method for monitoring a wind power installation and to a method for controlling a wind power installation. The invention also relates to a wind power installation.

### Description of the Related Art

Wind power installations, which generate electric power from wind and supply said electric power to an electrical supply system, are known generally. An example of such a wind power installation is depicted schematically in FIG. 1.

For effective control of such a wind power installation, it is particularly advantageous to capture or monitor the operating state of the wind power installation such that the wind power installation can be operated at as optimum an operating point as possible and that faults on the wind power installation are detected early.

Usually, modern wind power installations accomplish this by using a multiplicity of monitoring devices, which are in particular arranged at the trouble spots in the wind power installation in order to monitor the state of individual resources.

The publication WO 02/053910 A1, for example, discloses a device for monitoring the rotor blades that is arranged inside the rotor blades.

A drawback in this case is in particular that monitoring further resources, such as in the nacelle, for example, requires further monitoring devices.

Further, this is compounded by such monitoring devices, as shown in WO 02/053910 A1, being able to be retrofitted into already existing wind power installations only with a high level of outlay.

The German Patent and Trademark Office has performed a search of the following prior art in the priority application pertaining to the present application: DE 10 2008 026 842 B3, US 2009/0169378 A1, US 2009/0039650 A1 and US 2013/0268154 A1.

### BRIEF SUMMARY

Provided is a method that allows simple monitoring of the operating state of the wind power installation and/or for an inexpensive and redundant method that can easily be retrofitted onto already existing wind power installations.

Therefore, a method for monitoring a wind power installation having a nacelle is proposed, according to which an acoustic sensor arranged outside and on the nacelle is used to record a sound that is subsequently evaluated to detect an operating state of the wind power installation.

The acoustic sensor, which can also be referred to as a microphone, is in this case arranged outside and on the nacelle such that it captures at least some of the operating sounds of the wind power installation.

Operating sounds are understood in this context to mean essentially the sounds that are caused by the individual resources of the wind power installation. These include, by way of example, the hum of the generator or a sound that is produced in the event of stalling at the rotor blades. Preferably, the acoustic sensor initially records all sounds, however, so as then to evaluate particular sounds further.

It has been identified that sound evaluation can be used to detect a great many states and properties. By way of example, the reason is that, depending on wind direction and pitch angle, an aerodynamically different separation behavior arises for the wind flow at the rotor blade, resulting in particular, acoustically measurable sounds. In this case, the arrangement of the sound sensor outside the nacelle allows particularly such states to be captured as can otherwise be captured less well. These include icing-up or soiling of the rotor blades, an unfavorable incident flow of the wind and any damage to the rotor blade, for example as a result of a lightning strike. Similarly, erosion on the rotor blade can be detected, or at least this can be accomplished by virtue of a difference in comparison with a state without erosion being detected in the captured sound. The acoustic sensor can, accordingly, be used to perform at least rotor blade state monitoring, and the proposed method is further prepared to capture properties of the prevailing wind.

The recorded sound is then evaluated such that the operating state of the wind power installation and/or weather conditions can be inferred. In this case, it is advantageous to filter the recorded sound in a first step in order to eliminate any noise arising as a result of other wind power installations or the surroundings, for example.

Subsequently, the sound can be evaluated by means of an extended sound analysis or spectral analysis, in particular collated with known sounds or spectra of known sounds.

As a result, the method is provided to capture stall effects and shear effects, to measure the sound power level of the wind power installation, to monitor the state of the rotor blades and to take aerodynamic separation sounds as a basis for optimizing the pitch control. Such states or state changes can sometimes be detected or identified from a type and/or from the volume and the location of the recorded signal. In some cases, such as, e.g., for the detection of a shear effect, a directional sensitivity may also be useful for identification.

Preferably, the acoustic sensor is arranged atop the nacelle of the wind power installation, in particular on the highest point of the nacelle. It is also possible for multiple sensors to be used, or for multiple microphones to be used as a sensor. The use of an array of microphones is also a possibility and is proposed as a preferred embodiment. The use of multiple microphones, in particular the use of an array of microphones, allows particularly directionally sensitive functions to be performed. It is also possible to achieve a redundancy, so that the method can then essentially continue in the event of failure of a microphone.

As a result of the acoustic sensor being arranged atop the nacelle, that is to say above the widest point of the nacelle, the sensor has a particularly favorable position in order to capture the whole wind power installation acoustically.

In particular, this position is suitable in order to capture different operating states of individual resources, such as the nacelle and the rotor blades, for example, at the same time.

To capture the rotor blades, it is further advantageous to arrange the sensor on the highest point of the nacelle such that the distance from other resources of the wind power installation is as great as possible, in particular in order to minimize the influence of the stalls at the other resources such that a higher measurement accuracy for capturing the stalls of the rotor blades is achieved.

A stall is understood in this context to mean essentially the separation of the flow, in particular the laminar flow, from the surface of the resource, in particular the rotor blade, against which the wind flows, the stall also being referred to as a stall effect.

The present method thus comprises at least rotor blade state monitoring that can also be used to control a wind power installation.

Preferably, the operating state is detected by virtue of a sound power level of the wind power installation being recorded and evaluated.

A sound power level can be understood in this context to mean the sound emission, as recorded by the at least one sound sensor. Its cause lies in the wind power installation that actively causes it, that is to say as a result of the rotor blades, the generator, the yaw adjustment or other components, for example.

Accordingly, the sound power level of the wind power installation is made up of the sum total of all the operating sounds capturable at the nacelle and caused by the wind power installation. The acoustic sensor is thus prepared to capture at least these resources acoustically.

To this end, the acoustic sensor is configured as a highly sensitive microphone for example.

Preferably, the sound is recorded in directionally sensitive fashion.

For this, the sensor can have multiple recording sectors, for example, with individual sectors being able to be connected and/or disconnected. This allows the recorded sound to be broken down into multiple partial sounds such that each partial sound can be assigned a direction.

Accordingly, it is a simple matter for the direction of the sounds to be determined and/or for the recording and/or evaluation to be filtered in a first filter stage.

It is particularly advantageous in this case that any instances of sounds being overlaid and/or resultant errors can be specifically minimized in order to improve the quality of the recording and/or evaluation. The directionally dependent recording may also allow better localization of a sound.

In a particularly advantageous embodiment, the sensor further has a directional characteristic that is prepared to capture essentially only the operating sounds of the wind power installation. That is to say not capturing particular directions from which noise comes. The microphone, thus, has an omnidirectional or cardioid characteristic, for example.

Preferably, the sound is recorded in at least one frequency band in which sounds occur that are attributable to ice formation on the rotor blade.

Besides the active operating sounds of the wind power installation, operating sounds that are not caused solely by the wind power installation are also captured.

These include sounds that are brought about by ice formation on the rotor blade, for example. Depending on the embodiment of the rotor blade, the ice formation on the rotor blade results in a turbulent circulatory flow that produces a characteristic sound that is in a frequency band that can be captured by the sensor. Moreover, or additionally, stalls can also occur that can likewise result in a sound that is characteristic of them.

In particular, this allows particular stalls on the wind power installation to be captured that indicate particular weather conditions, such as ice formation, for example.

The acoustic sensor means that the method is therefore prepared to capture the weather or the prevailing weather condition indirectly.

Preferably, the sound is recorded and/or evaluated when the wind power installation is at a standstill.

The sensor or the monitoring apparatus having a sensor is, therefore, used to capture a sound even when the wind power installation is at a standstill. As a result, it is also possible for a redundant measurement system to be achieved if there is a further sensor for the variable to be measured. By way of example, it is known practice to check a wind speed captured by an anemometer using operating parameters such as delivered power or blade position. This works only during operation of the installation, however. As the method proposed herein may be employed when the installation is at a standstill however, a fully redundant wind measurement system can be achieved.

The recording and/or evaluation of the sound when the wind power installation is at a standstill further allows the operating state of the wind power installations to be captured before the wind power installation is started up again. As a result, it is also possible to detect if wind conditions change such that the wind power installation can be started.

When the installation is at a standstill, the sounds as a result of the wind on the rotor blades, on the nacelle, on nacelle superstructures or on the tower can arise, for example, and can contain characteristic tones that can provide e.g., information about wind speed and wind direction.

Preferably, the evaluating of the recorded sound to detect the operating state is effected externally, in particular by a monitoring center.

The evaluating of the recorded sound, that is to say the evaluation of the sound power level of the wind power installation, is preferably effected in a control room or monitoring center that connects to the microphone as required, for example. In the event of the control room connecting to the microphone, the sound is thus transferred to the control room. This can be done by means of a transmitter and/or via the internet, for example.

The installation operator can therefore monitor the wind power installation independently of its operating state. If said installation operator then discovers damage to the wind power installation, it can prepare the maintenance personnel for the repair work as appropriate.

It is particularly advantageous in this case that the maintenance personnel is already aware of the fault on arrival in situ, resulting in much shorter installation times.

Preferably, the evaluating of the recorded sound to detect the operating state is effected by means of a spectral analysis, in particular by means of a Fast Fourier Transformation or a narrowband analysis.

The sound is, accordingly, evaluated by means of analytical methods that are used to break down the sound into individual frequency bands.

In this case, the breakdown into the frequency bands is preferably affected such that said frequency bands have the applicable and known frequency bands of the resources. Accordingly, the frequency bands produced by the analytical method can easily and expediently be collated with already known frequency bands. Such known frequency bands can be measured and appropriately stored in advance. Every installation state can therefore have its own individual “finger print”.

If the rotor of the wind power installation rotates at a speed of twelve revolutions per minute, for example, corresponding to a frequency of 0.2 Hz, passage of the rotor blades over the tower at a frequency of 3*0.2 Hz can occur, for example, if there are three rotor blades. Any lower or higher frequencies differing from this exemplary 3*0.2 Hz could indicate that the wind power installation is not at the optimum operating point and the installation needs to be regulated accordingly.

The analysis method chosen can be not only spectral analysis but also Fast Fourier Transformation, narrowband analysis or incoherent demodulation, for example, by means of envelopes. The resolution of the method is chosen such that it is, accordingly, possible to distinguish between the different frequency bands of the resources. Other amplitude modulation methods familiar to a person skilled in the art can also be used therefor, however.

Preferably, a method for controlling operation of at least one wind power installation is proposed, according to which a sound of a wind power installation is recorded using an acoustic sensor arranged outside and on a nacelle of a wind power installation, the recorded sound is evaluated to detect an operating state of the wind power installation comprising the acoustic sensor and operation of a wind power installation is controlled on the basis of the operating state of the wind power installation comprising the acoustic sensor.

The operation of a wind power installation, in particular of the wind power installation comprising the acoustic sensor, is accordingly controlled on the basis of a recorded sound, further input variables being able to be taken into consideration. By way of example, if the sound level is too high, in particular if there is a specific sound level or a specific amplitude profile, the pitch control is controlled such that the sound level of the wind power installation is reduced. It is also possible for the wind power installation to be shut down in the event of an unfavorable or excessive sound level, which indicates a serious fault that can lead to further damage to the wind power installation.

In this case, the recorded sound comprises at least one sound from a resource of a wind power installation. Accordingly, the acoustic sensor is configured to capture sounds specific to wind power installations, particularly frequency bands of the resources, such as a pitch drive, for example. Alternatively, specific characteristics can be captured that have particular amplitudes and/or a particular amplitude distribution at particular frequencies, for example.

The proposed method for controlling the wind power installation may be configured as a redundant method for controlling a wind power installation because it uses the monitoring method described according to at least one embodiment as a redundant method. Using such a monitoring method also allows optimization of the installation control to be achieved, particularly because the results of this monitoring are used as additional measured values for redundancy, for checking or as a supplement to create a larger measurement database. In particular, it is proposed that this be used to optimize the yield of wind power installations.

Further, according to one refinement, it is proposed that the wind power installation be restricted or powered down by means of the present method in the event of a faulty operating state being detected.

In a preferred embodiment, this method is used to control a second wind power installation. In particular, on discovering damage, the damaged wind power installation is restricted and at least one second wind power installation of the power corresponding to the restriction is powered up.

Preferably, the recorded sound is taken as a basis for controlling at least one state from the list consisting of:
at least one pitch angle of a rotor blade,
a yaw angle,
a rated power and
a rated speed of a wind power installation.

Accordingly, to optimize yield, for example, a pitch angle of a rotor blade or the yaw angle of a wind power installation is controlled on the basis of the recorded sound. The wind power installation is thus, in order to optimize the yield, oriented on the basis of the captured stall at the rotor blade in the wind, for example.

Further, the method can also be used to regulate the sound power level of the wind power installation such that, while observing guarantee values, in particular emission requirements, the maximum possible sound power level is used so as to maximize the yield of the wind power installation.

Preferably, the acoustic sensor arranged on the nacelle provides the recorded sound in response to an external inquiry, in particular to a unit that made the inquiry.

The acoustic sensor is thus configured to forward the recorded sound to an external unit, for example by internet transmission. External units are intended to be understood to mean in particular control rooms or monitoring centers that are used to control wind power installations and/or wind farms.

By way of example, a technical office staff can connect to the microphone or listen to sound recordings on line and, thus, obtain a direct impression of the sound emissions without going to the installation.

A particular advantage in the case of external evaluation of the sound is that the control room or the technical office staff can connect to the acoustic sensor, so as to check the operating state of the wind power installation, even when the wind power installation is at a standstill or in blackout.

Preferably, the acoustic sensor is embodied in self-sufficient fashion and/or the wind power installation is controlled externally on the basis of the recorded sound.

It is, thus, proposed that the sensor be embodied such that it is merely mechanically mounted on the wind power installation. Accordingly, the acoustic sensor at least has a power supply of its own and a data interface in order to transmit, in particular to stream, the recorded sound to a control room.

The sensor is thus part of a monitoring apparatus that forms a self-contained module that can easily be retrofitted on a wind power installation.

Further, it is proposed that the wind power installation be controlled externally, that is to say by a control room, for example.

The acoustic sensor is accordingly not directly connected to the control of the wind power installation. The data are first sent to a control room and evaluated there. Subsequently, the control room can then start up the wind power installation having the sensor on the basis of the recorded sound, in particular the control room can control the wind power installation having the sensor on the basis of the recorded sound.

A particular advantage in this case is that the proposed method allows both redundant measurement and overlaid control of the wind power installation. The operator of the wind power installation can therefore take action in the operation of the wind power installation by means of an independent measurement. This is particularly desirable if the wind power installation has internal control errors, for example as a result of a faulty anemoscope that conveys an incorrect wind direction. This is because, in such cases, the wind power installation is then at an angle in the wind, resulting in a considerable minimization of yield.

Preferably, the wind power installation is controlled by using a monitoring method according to at least one of the embodiments described above.

The method for controlling the wind power installation thus comprises at least one of the steps described above for monitoring a wind power installation.

Preferably, a monitoring apparatus for monitoring a wind power installation having a nacelle is provided, wherein the monitoring apparatus comprises an acoustic sensor arranged outside and on the nacelle for recording a sound, and comprises an evaluation device for evaluating the recorded sound to detect an operating state of the wind power installation. To this end, it is provided that the sensor be weatherproof, in particular be able to be exposed to wind, rain and other precipitation.

The monitoring apparatus is accordingly configured for installation on a wind power installation and has at least one acoustic sensor that can capture an operating sound spectrum of a wind power installation. In particular, the acoustic sensor can capture this sound spectrum in sensitive fashion, for example in directionally sensitive fashion.

The monitoring apparatus also comprises a transmitter and/or receiver in order to transmit the recorded sound to a control room and/or to make the recorded sound available by means of a memory for later, external access. Further, the monitoring apparatus has a power supply that is independent of the wind power installation, and is configured to be mounted on the nacelle of a wind power installation.

Preferably, the monitoring apparatus is configured to carry out one of the above methods. In particular, it is proposed that one or more method steps of a method according to at least one embodiment described above be implemented in a process control unit of the monitoring apparatus.

Preferably, the monitoring apparatus has a data interface, for the purpose of interchanging data, in particular for transmitting data recorded by the acoustic sensor and/or for transmitting data evaluated by the evaluation device. The interchange of data is proposed particularly between the process control unit of the monitoring apparatus and external apparatuses; particularly control rooms.

A wind power installation having a nacelle and at least one acoustic sensor arranged on the outside of the nacelle for recording sounds is also provided, wherein the wind power installation uses a monitoring apparatus according to at least one embodiment described above and/or carries out a method according to at least one embodiment described above.

Further, a wind farm comprising at least two wind power installations is also proposed, wherein at least one wind power installation has a monitoring apparatus as described above and/or is configured to perform at least one of the method steps described above.

Preferably, it is proposed that the wind power installations of the wind farm be networked for the purpose of interchanging the recorded sounds and/or the evaluated sounds, in particular in order to control the wind power installations on the basis of a recorded sound.

Accordingly, it is proposed that a wind farm be controlled on the basis of a recorded sound.

For the sound, it is possible to tell whether there is icing, because the ice alters the sound spectrum. Particularly the rotor blades give off a different sound if they have ice. The sounds distinguish whether, how and how quickly the blades are moving and possibly what blade angle is set. Even at a standstill, a sound is produced as soon as there is a little wind and the sound is altered by icing. There may be added sounds from falling ice. Different sounds can also be produced by means of the lands of the blade, and from this it is possible to attempt to infer the position of the ice.

In the event of soiling of or damage to the rotor blade too, these alter the sound that emanates from the blades. The position of said soiling or damage on the blade has an influence on the sound in this case too.

By way of example, a clean, ice-free and undamaged rotor blade can be assigned a sound spectrum. If this sound spectrum is recorded as usual, that is to say as previously, everything should be in order with the relevant rotor blade. If differences arise, specifically if something is missing, then there must have been an alteration of the blade, which can possibly also be attributed even more precisely, both according to location and according to type. If there is nothing missing from the usual sound spectrum, however, but something has been added, this could mean that the blade is unaltered and the additional feature has another cause.

### BRIEF DESCRIPTION OF THE SEVERAL VIEWS OF THE DRAWINGS

The present invention is now explained in more detail below by way of example using exemplary embodiments with reference to the accompanying figures.

FIG. 1 shows a schematic depiction of a wind power installation.

FIG. 2a shows a schematic depiction of the wind power installation in a plan view.

FIG. 2b shows the schematic depiction of the wind power installation in a plan view as shown in FIG. 2a, the wind power installation having an ice formation on the rotor blade.

FIG. 3 shows a diagram of a method for monitoring a wind power installation according to an embodiment.

FIG. 4 shows a diagram of a method for controlling a wind power installation according to an embodiment.

FIG. 5 shows a schematic depiction of a spectral analysis.

FIG. 6 shows a monitoring apparatus.

### DETAILED DESCRIPTION

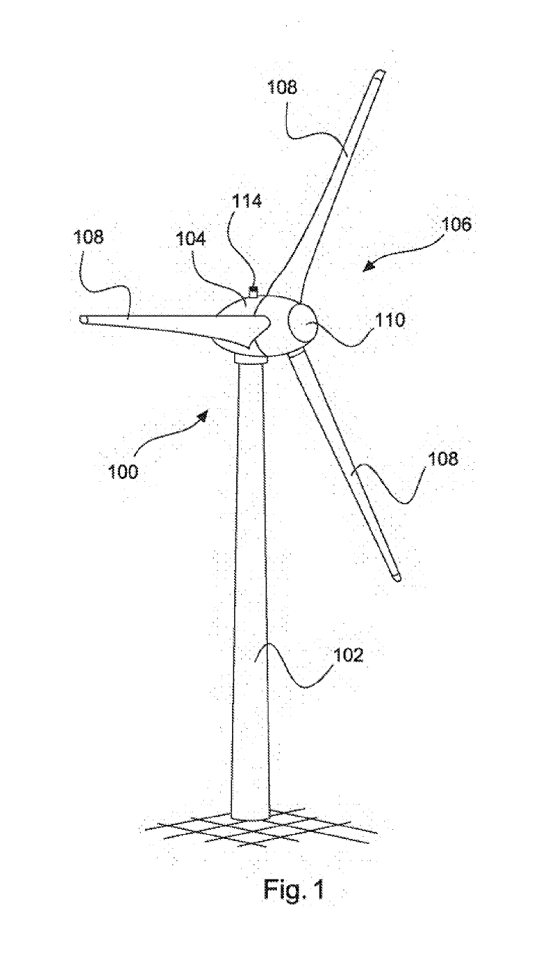

FIG. 1 shows a wind power installation 100 having a tower 102 and a nacelle 104. Arranged on the nacelle 104 is a rotor 106 having three rotor blades 108 and a spinner 110. The rotor 106 is set in a rotary motion by the wind during operation and thereby drives a generator in the nacelle 104. Arranged outside and on the nacelle is an acoustic sensor 114, or alternatively there may even be two acoustic sensors 114 provided, for example.

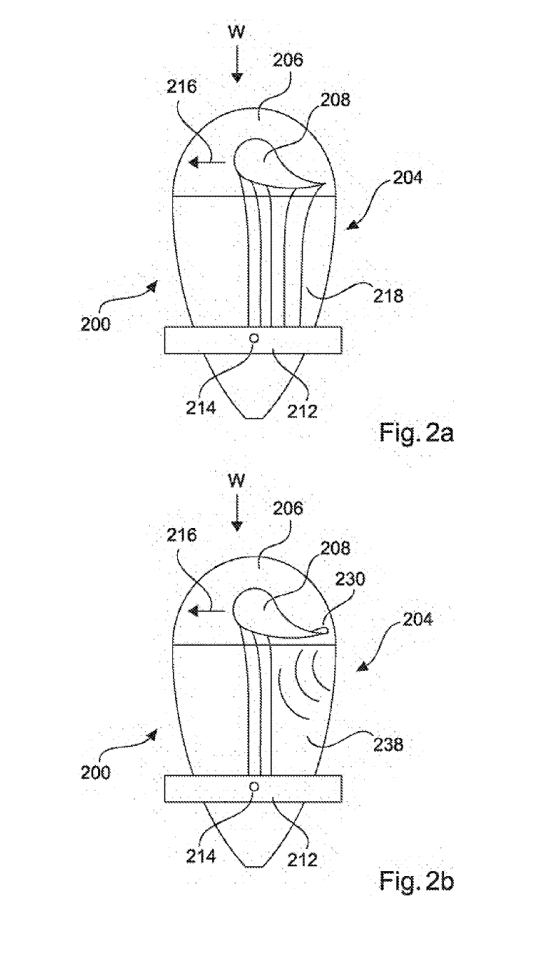

FIG. 2a shows a wind power installation 200 as shown in FIG. 1 in a plan view, the rotor 206 rotatably mounted on the nacelle 204 having only one of the three rotor blades 208 in a 12-o'clock position for the purposes of illustration. Further, mounted above and on the nacelle 204 is an instrument carrier 212 that has an acoustic sensor 214, in particular a monitoring apparatus 214.

The rotor blade 208, together with the rotor 206, is arranged rotatably in relation to the rest of the nacelle 204. The wind W causes the rotor blade 208 to rotate in the direction of rotation 216 denoted by the arrow. In so doing, the rotor blade 208 causes a stall 218 that, as seen from the wind direction W, is behind the rotor blade 208. It is pointed out that the depiction is schematic and particularly depicts the stall only schematically.

The laminar stall 218, which is, therefore, depicted only in simplified fashion in this case, is measurable in the form of a sound and is captured by the acoustic sensor 214, which is configured as a microphone. Depending on the angle of attack and position of the rotor blade 208 in relation to the wind W, the stall 220 can vary.

By way of example, the separation of the laminar flow takes place at another point on the rotor blade surface, or the laminar flow envelopes the rotor blade to produce a turbulent flow. Such and further alterations in the stall, which are caused in particular by the pitch angle, can be captured by the acoustic sensor and evaluated.

FIG. 2b, which is essentially based on FIG. 2a, shows the same depiction of a wind power installation 200 as shown in FIG. 1, the rotor blade 208 having icing 230, which can also be referred to as ice formation 230.

The ice formation 230, in contrast to an ice-free rotor blade 208, causes an altered stall 238, which is likewise depicted only in simplified fashion. This altered stall 238 is likewise measurable in the form of a sound and is captured by the microphone 214. The sound recorded in this manner differs perceptibly from a sound of an ice-free rotor blade, which means that the ice formation 230 on the rotor blade 208 is detected by means of a simple collation.

Both FIG. 2a and FIG. 2b show just one example of a capture of an operating state of a resource of a wind power installation. The acoustic sensor and the proposed methods are also suitable for capturing further operating states of other resources, such as the generator and the nacelle, for example. The capture of further operating states can accordingly take place at the same time using the same recorded sound.

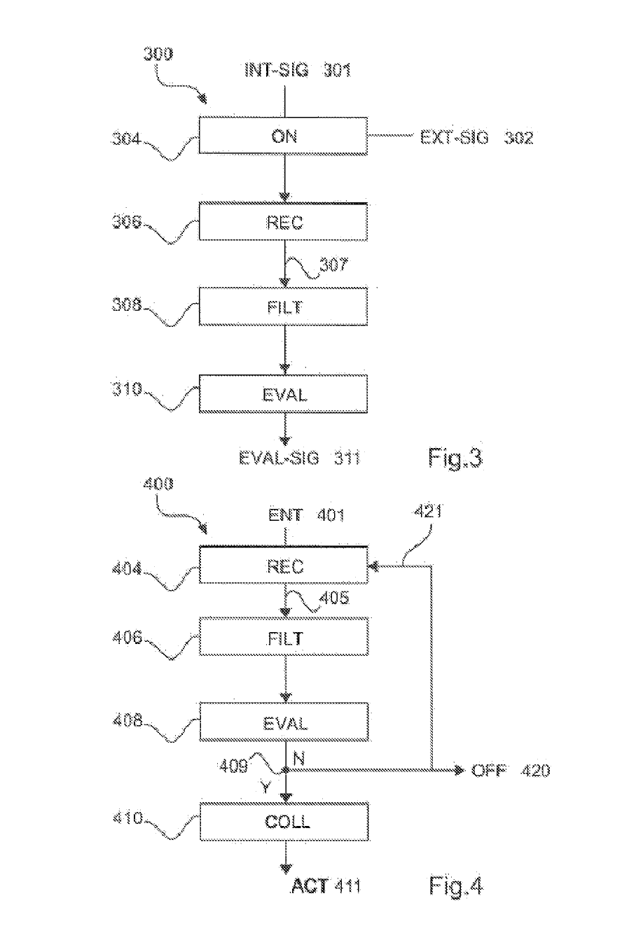

FIG. 3 uses an overview 300 to illustrate a method for monitoring a wind power installation according to a preferred embodiment. The wind power installation has an acoustic sensor outside and on, in particular atop, the nacelle for the purpose of monitoring an operating state of the wind power installation.

The acoustic sensor is switched on in response to a signal. The signal used is an internal signal in the wind power installation 301 or an external signal from the control room 302. After it has been switched on 304, the acoustic sensor, that is to say the microphone, begins to record the sound 306 that surrounds the nacelle of the wind power installation. What is recorded 306 is subsequently transferred 307 to a filter in order to eliminate spurious signals in what is recorded. The filtering 308 takes place either internally, namely in particular in the monitoring apparatus having the sensor or externally. The monitoring apparatus comprises at least one sensor and may further also comprise a filter and an evaluation unit. Alternatively, the filtering can take place externally in a control room. For external filtering, the recorded sound is then transmitted to the control room by means of a stream via a wireless local area network (WLAN), for example.

After the filtering 308, the sound is evaluated. For evaluation 310, a spectral analysis is performed, for example, which involves the recorded and filtered sound being broken down into individual frequency bands. These frequency bands can then be collated with known frequency bands. In the event of a discrepancy between these frequency bands, a fault signal 311 would then be output, which is processed further.

The fault signal 311 can be realized by a warning signal in the control room, for example, the personnel in the control room then being able to initiate further steps in order to correct the fault.

FIG. 4 uses an overview 400 to illustrate a method for controlling a wind power installation according to a preferred embodiment, wherein the wind power installation has an acoustic sensor atop the nacelle for the purpose of control and comprises a method as described above for monitoring a wind power installation, and wherein the wind power installation is controlled externally on the basis of the recorded sound.

A control room, that is to say an external monitoring center, does this by connecting to a monitoring apparatus 401 on the wind power installation, the monitoring apparatus comprising an acoustic sensor that is arranged atop the nacelle of the wind power installation.

The acoustic sensor, which is embodied as a microphone, records the sound surrounding the nacelle and transfers it to the control room. What is recorded 404 is thus transmitted 405 to the control room.

There, the sound is filtered 406 and subsequently evaluated 408, for example by means of a spectral analysis.

The evaluation 408 establishes whether there is a fault in a resource of the wind power installation 409. If there is no fault, the control room can either disconnect 420 from the sensor or continue to transmit 421 the sound. If there is a fault, a collation is performed with a control database that uses a database to compute the most favorable controlled variable for controlling the wind power installation. This controlled variable 411 is then used to actuate the applicable resource.

In the simplest case, the control room discovers an incorrect stall at the wind power installation and then controls the yaw angle of the nacelle accordingly. In another exemplary case, the wind power installation is at a standstill and the control room connects to the microphone before the installation is started up. In this case, the control room discovers icing on the rotor blades and uses a collation 410 to decide either to deice the blades by means of heating or not to start up the installation yet.

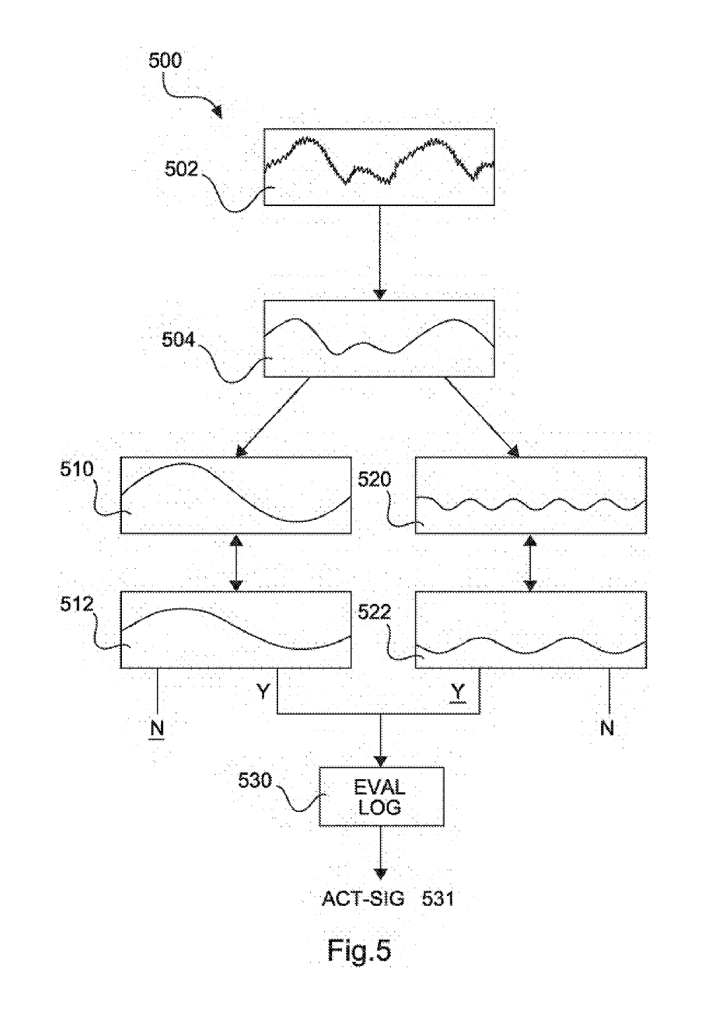

FIG. 5 schematically shows an evaluation, in particular a spectral analysis, of a recorded sound 500.

Accordingly, a sound 502 surrounding the nacelle of the wind power installation is first of all recorded using a microphone arranged atop the nacelle of the wind power installation.

The sound recorded in this way is subsequently filtered to produce an essentially noise-free sound 504. This can be done by means of high and/or low pass filtering, for example.

Subsequently, the filtered sound is broken down into determined frequency bands 510 and 520 using a spectral analysis. The breakdown into two frequency bands is intended to convey the principle only simplistically; the evaluation is not restricted to such a breakdown into two bands.

The determined frequency bands 510 and 520 are collated with the known frequency bands 512 and 522. The frequency band 510 corresponds, by way of example, to the frequency band 510 of the recorded sound of the rotor blades and the frequency band 520 corresponds to the frequency band 520 of the recorded sound of the yaw adjustment. These are collated with the frequency bands 512 and 522 known for the rotor blades and the yaw adjustment. The known frequency bands can be ascertained a priori, for example, by means of simulation or measurement in situ. Alternatively, iterative determination of the known frequency bands 512 and 522 in the course of ongoing operation of the wind power installation is possible.

If a discrepancy is ascertained during this collation of the frequency bands, said discrepancy is transferred to evaluation logic 530 that then collates potential control processes with one another and outputs a preferred control signal 531.

FIG. 5 shows an example, and in this case the recorded frequency band 520 for the yaw adjustment has a discrepancy in relation to the known frequency band 522 for the yaw adjustment. This discrepancy is now transferred to the evaluation logic 530, which triggers a preferred control signal 531. By way of example, the angle of attack of the rotor blades is altered in order to correct the discovered discrepancy.

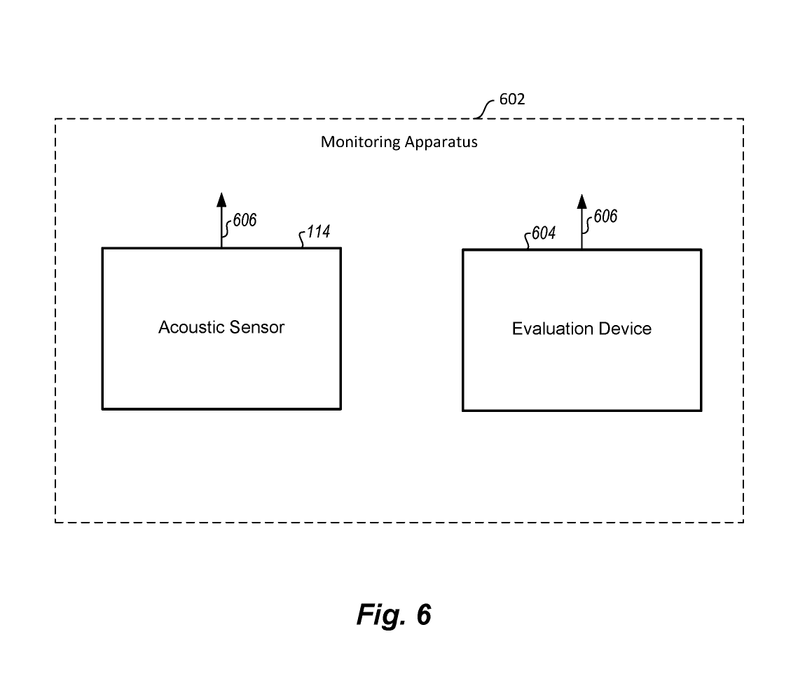

FIG. 6 shows a monitoring apparatus 602. The monitoring apparatus 602 comprises the acoustic sensor 114 and an evaluation device 604. The monitoring apparatus 602 has a data interface 606 for transmitting data recorded by the acoustic sensor 114 and/or for transmitting data evaluated by the evaluation device 604.

1. A method for monitoring a wind power installation having a nacelle, comprising:
recording a sound using at least one acoustic sensor arranged outside and on the nacelle, and
evaluating the recorded sound to detect an operating state of the wind power installation.

2. The method as claimed in claim 1, wherein the acoustic sensor is arranged atop the nacelle.

3. The method as claimed in claim 1, comprising:
detecting the operating state using a sound power level of the recorded sound of the wind power installation.

4. The method as claimed in claim 1, wherein recording the sound includes recording the sound in a directionally sensitive fashion.

5. The method as claimed in claim 1, wherein recording the sound includes recording the sound in at least one frequency band in which sounds occur that are attributable to ice formation on a rotor blade of the wind power installation.

6. The method as claimed in claim 1, wherein at least one of: recording the sound includes recording the sound when the wind power installation is at a standstill or evaluating the recorded sound includes evaluating the sound recorded when the wind power installation is at the standstill.

7. The method as claimed in claim 1 comprising:
evaluating of the recorded sound to detect the operating state externally, by a monitoring center.

8. The method as claimed in claim 1, wherein evaluating the recorded sound to detect the operating state includes performing spectral analysis on the recorded sound.

9. A method for controlling operation of at least one wind power installation, comprising:
recording a sound of the at least one a-wind power installation using an acoustic sensor arranged outside and on a nacelle of the at least one wind power installation,
evaluating the recorded sound to detect an operating state of the at least one wind power installation including the acoustic sensor, and
controlling the operation of the at least one wind power installation based on the detected operating state of the at least one wind power installation including the acoustic sensor.

10. The method as claimed in claim 9, comprising:
controlling, based on the recorded sound, at least one state from a list including:
at least one pitch angle of a rotor blade of the at least one wind power installation,
a yaw angle of the at least one wind power installation,
a rated power of the at least one wind power installation, and
a rated speed of the at least one wind power installation.

11. The method as claimed in claim 9 comprising:
receiving, by the acoustic sensor arranged on the nacelle, external inquiry from an external unit, and
transmitting the recorded sound externally to the external unit.

12. The method as claimed in claim 9, wherein the acoustic sensor is a self-sufficient sensor having a standalone arrangement, and wherein the at least one wind power installation is controlled externally based on the recorded sound.

13. (canceled)

14. A monitoring apparatus for monitoring a wind power installation having a nacelle, comprising:
an acoustic sensor arranged outside and on the nacelle for recording a sound, and
an evaluation device for evaluating the recorded sound to detect an operating state of the wind power installation.

15. The monitoring apparatus as claimed in claim 14, wherein the acoustic sensor has multiple microphones arranged as an array of microphones.

16. The monitoring apparatus as claimed in claim 14, comprising:
a data interface for transmitting the sound recorded by the acoustic sensor or for transmitting data evaluated by the evaluation device.

17. A wind power installation having a nacelle and at least one acoustic sensor arranged on the outside of the nacelle for recording sounds, comprising:
the monitoring apparatus as claimed in claim 14.

18. A wind farm, comprising at least two wind power installations including the wind power installation as claimed in claim 17.

19. The wind farm having as claimed in claim 17 in which the two wind power installations are networked with each other and are configured to exchange data via the monitoring apparatus.
